(19) United States
(12) Patent Application Publication
(10) Pub. No.: US 2026/0084223 A1
(43) Pub. Date: Mar. 26, 2026

(54) PROCESSING MACHINE

(71) Applicant: Hinterkopf GmbH, Eislingen/Fils (DE)

(72) Inventors: Timo EGETENMEIER, Schwäbisch Gmünd (DE); Stefan DREXLER, Bad Überkingen/Hausen (DE)

(21) Appl. No.: 19/335,922

(22) Filed: Sep. 22, 2025

(30) Foreign Application Priority Data
Sep. 23, 2024 (EP) 24201880.2

(51) Int. Cl. B23B 31/30

(52) U.S. Cl. CPC B23B 31/30

(57) ABSTRACT

A processing machine for machining container blanks, with a machine base and a workpiece rotary table mounted rotatably about a rotational axis on the machine base, with a drive for providing a rotary step movement between machine base and workpiece rotary table, with pneumatically actuated collets and pneumatic valves assigned to the collets, which can be switched between a ventilation position and a venting position. The pneumatic valves are connected to a compressed air reservoir, with a fluid coupling for a supply of compressed air to the compressed air reservoir, which has a first coupling part mounted movably on the machine base and a second coupling part which is arranged opposite the first coupling part on the workpiece rotary table. The first coupling part rests sealingly against the second coupling part in a coupling position and is spaced apart from the second coupling part in a rest position.

### CROSS-REFERENCE TO RELATED APPLICATION

This application claims priority to European application no. 24201880.2 filed September 23, 2024, which is incorporated by reference.

### BACKGROUND

The invention relates to a processing machine for machining container blanks, as known, for example, from EP 2363216 B1.

Such processing machines use either hydraulically operated collets or pneumatically operated collets, with pneumatically operated collets becoming increasingly widespread because they are easier to handle than hydraulically operated collets due to the use of compressed air as the working medium. The collet also can be named chuck, collet chuck or gripper.

### SUMMARY

The objective of the invention is to provide a processing machine equipped with pneumatically actuated collets for which simplified actuation of the pneumatically actuated collets is to be achieved.

This task is solved for a processing machine of the type as mentioned above in that the processing machine has a machine base, in particular comprising a machine frame, and a workpiece rotary table, wherein the workpiece rotary table is rotatably mounted on the machine base so as to be rotatable about a rotational axis, and with a drive fixed to the machine base, which is designed to provide a rotary step movement for the workpiece rotary table, wherein pneumatically actuated collets are attached to a workpiece surface of the workpiece rotary table, which collets are designed for releasable fixing of container blanks on the workpiece rotary table, each collet being assigned a pneumatic valve that can be switched between a ventilation position (aeration position) for the collet and a venting position (exhaust position) for the collet, the processing machine further having a plurality of pneumatic valves being connected to a compressed air reservoir fixed to the workpiece rotary table, and having a fluid coupling to supply compressed air to the compressed air reservoir, which fluid coupling has a first coupling part which is movably mounted on the machine base, and which has a second coupling part which, in particular in a coupling plane aligned transversely to the axis of rotation, is arranged opposite the first coupling part on the workpiece rotary table, wherein the first coupling part rests sealingly against the second coupling part in a coupling position and is spaced apart from the second coupling part in a rest position.

The container blanks that can be machined using the processing machine are preferably blanks for aerosol cans, which have at least a substantially circular cylindrical side wall and a concave-shaped bottom area. The container blanks are typically clamped in the respective collet at a side wall section adjacent to the bottom area, wherein the clamping is based on friction (force-fit).

To secure the container blank in the collet, an elastically deformable, in particular annular, area of the collet is designed to bulge inwards in the radial direction, thereby reducing the inner diameter of a recess in the collet designed to accommodate the container blank partially in a certain area, preferably in an area close to the bottom area. For example, it is provided that an axial movement of a working piston of the collet is caused by a supply of compressed air to the collet, whereby a rubber-elastic retaining ring, which is arranged coaxially adjacent to the working piston, is compressed in the axial direction and thereby performs an evasive movement in the radial direction inwards. Alternatively, it may be provided that a rubber-elastic retaining ring radially limits a ring-shaped working space in the collet towards the inside and can be bulged inwards in the radial direction by applying pressure to the working space.

The collets are preferably arranged at constant angular intervals and at a fixed distance from a rotational axis of a workpiece rotary table on a substantially circular workpiece surface of the workpiece rotary table. In this case, the axes of extension, in particular the axes of rotational symmetry, of the recesses, in particular circular cylindrical recesses, formed in the collets for receiving the container blanks are each aligned parallel to the axis of rotation of the workpiece rotary table. The workpiece rotary table, which is mounted on the machine base so as to be rotatable and is also referred to as a major component of the carrier part, is set in a rotary step motion by a drive fixed to the machine base when the processing machine is used as intended. The drive is, for example, a servomotor which is designed to provide the rotary step movement of the workpiece rotary table via an intermediate gear device acting on the workpiece rotary table.

Preferably, the drive is designed as a direct drive, in particular as a torque motor, which enables the rotary step movement to be provided to the workpiece rotary table without a gear. In this case, a stator is mounted to the machine base, wherein this stator comprises electric coils for providing a moving magnetic field. The workpiece rotary table is equipped with permanent magnets, such that the moving magnetic field from the stators results in a toque that drives the rotational movement of the workpiece rotary table. The rotary step movement for the workpiece rotary table is adapted to the angular interval (angular division) of the collets, so that the workpiece rotary table performs a sequence of acceleration and deceleration starting from a preceding angular position in order to carry out the rotary step movement until it assumes a subsequent angular position that differs from the preceding angular position by the angular interval of the collets. The angular interval of the rotary step movement is calculated by dividing 360 degrees by the number of collets. Typically, the workpiece rotary table performs all rotary step movements in the same direction of rotation around the axis of rotation.

One of the tasks of the collets is to transfer the accelerations occurring during the rotary step movement to the container blanks and to ensure that the alignment of the container blanks does not change either during the execution of the rotary step movement or during the execution of machining of the container blanks in the rest phases between the individual rotary step movements. Another task of the collets is to transfer the machining forces occurring during machining of the container blanks to the workpiece rotary table and from there to the machine base, unless contactless machining of the container blanks is planned.

In order to carry out machining operations with the processing machine, the workpiece rotary table is designed to perform a sequence of rotary step movements so that the collets and the container blanks held therein are moved along a circular motion path. This movement path extends from a stationary loading station, arranged in particular on the machine base, for feeding container blanks to the workpiece rotary table, to a stationary unloading station, arranged in particular on the machine base, for removing the container blanks from the workpiece rotary table. Typically, the container blanks are inserted into the respective collet at the loading station by a loading movement aligned parallel to the axis of rotation of the workpiece rotary table and are removed from the respective collet at the unloading station by an unloading movement aligned parallel to the axis of rotation of the workpiece rotary table. Furthermore, it is intended that after the container blank has been inserted into the respective collet, the container blank is secured in the collet by ventilating (pressure increase) or venting (pressure decrease) the collet.

Usually, the container blank is kept secured for the entire movement path between the loading station and the unloading station. At the unloading station, the collet is vented (pressure decrease) or aerated (pressure increase) in order to release the force-fit connection between the collet and the container blanks and to enable the container blank to be removed from the collet with low friction. Depending on the design of the collet, the clamping process for the container blank is effected either by aeration/ventilation of the collet or by venting of the collet. Ventilation refers to the supply of compressed air to the collet, while venting refers to the removal of compressed air from the collet.

In order to enable the required compressed air supply or compressed air discharge at the loading station and at the unloading station, each collet is assigned a pneumatic valve that can be switched between a ventilation position and a venting position. The pneumatic valve is preferably a switching valve that can be switched between the ventilation position and the venting position depending on an external energy supply. The pneumatic valve is preferably designed as a 3/2-way valve that can be switched between the ventilation position and the venting position. Alternatively, the pneumatic valve is designed, for example, as a 3/3-way valve which, in addition to the ventilation position and the venting position, has a blocking position in which no compressed air flows into or out of the collet.

In order to enable an advantageous compressed air supply for the collets, at least one compressed air reservoir is attached to the workpiece rotary table, which is connected to several pneumatic valves in a fluid-communicating manner, so that the collets connected to the pneumatic valves can be supplied with compressed air from the compresses air reservoir depending on a switching position of the respective pneumatic valve. It is preferable that all pneumatic valves arranged on the workpiece rotary table are fluidically connected to one compressed air reservoir attached to the workpiece rotary table. Alternatively, groups of pneumatic valves can be connected with one of several compressed air reservoirs attached to the workpiece rotary table.

In order to enable the supply of compressed air to the at least one compressed air reservoir without requiring a technically complex and maintenance-intensive rotary feedthrough between the machine base and the workpiece rotary table, the processing machine has a fluid coupling that is designed for a temporary fluidic connection between the machine base and the workpiece rotary table. For this purpose, the fluid coupling comprises a first coupling part, which is movably mounted on the machine base, and a second coupling part, which is attached to the workpiece rotary table. It is provided that the first coupling part can be moved between a rest position, in which there is a distance to the second coupling part, and a coupling position, in which the first coupling part rests sealingly and fluidically communicatively on the second coupling part. Since the second coupling part attached to the workpiece rotary table moves in the same way as the collets on a circular path aligned concentrically with the axis of rotation, the first coupling part is attached to the machine base in such a way that, at least in a rotational position which the workpiece rotary table assumes between the execution of successive rotary step movements, it is exactly opposite the second coupling part. It is preferable that the first coupling part is movable along a path of movement aligned parallel to the axis of rotation. It is particularly preferable that several second coupling parts are provided, which are arranged on the workpiece rotary table opposite the first coupling part, in particular in a coupling plane aligned transversely to the axis of rotation.

Advantageous further developments of the invention are the subject of the subclaims.

It is advantageous if a drive housing of a linear drive is attached to the machine base and if the first coupling part is attached to a coupling rod of the linear drive, which linear drive is designed for providing a linear relative movement of the coupling rod with respect to the drive housing and to the machine base. Preferably the linear movement is oriented parallel to the axis of rotation. The first coupling part can be moved by the relative movement between the rest position and the coupling position.

The linear drive is designed to provide a linear working movement and can be designed, for example, as a hydraulic cylinder or as an electric linear direct drive or as an electric threaded spindle drive. In any case, the linear drive is designed to have a drive housing and a coupling rod mounted relatively movably on or at least partially in the drive housing, which coupling rod can change position relative to the drive housing by supplying energy to the linear drive. Typically, the drive housing is attached to the machine base and the first coupling part is attached to the coupling rod. Alternatively, the coupling rod is attached to the machine base, and the drive housing is connected to the first coupling part. It is preferred that the linear movement of the coupling rod relative to the drive housing takes place along a straight line of movement that is aligned parallel to the axis of rotation of the workpiece rotary table. In this case, it may also be provided that a first coupling surface of the first coupling part and a second coupling surface of the second coupling part lie in planes that are parallel to each other and aligned transversely to the axis of rotation.

Alternatively, it may be provided that the first coupling part performs a swiveling movement on a curved path, in particular a circular path section, or a helical movement as a combination of a swiveling movement and a linear movement between the rest position and the coupling position.

It is advantageous if the first coupling part is assigned a fluid valve which is designed to supply compressed air from the first coupling part to the second coupling part when the first coupling part is in the coupling position and to block an air flow if the first coupling part is not in the coupling position. In order to ensure the most efficient use of compressed air required for actuating the collets, compressed air is only supplied when the first coupling part is sealingly engaged with the second coupling part. For this purpose, a fluid valve is arranged in a compressed air supply line extending between a compressed air source and the first coupling part, which can be switched between a shut-off position for blocking an air flow and a release position for providing an air flow. The fluid valve is preferably a switching valve, for example a 2/2-way valve or a 3/2-way valve, in particular an electrically controllable solenoid valve. Alternatively, a proportional valve can also be used to influence the compressed air flow between the first coupling part and the second coupling part. It is preferred that the fluid valve is switched between the shut-off position and the release position depending on the position of the first coupling part, so that the fluid valve is only switched from the shut-off position to the release position if there is a minimum distance between the first coupling part and the second coupling part. It is particularly preferred that coordination between the control of the linear drive and the control of the fluid valve is carried out by an electrical or electronic control system associated with the machine base.

It is preferred that the linear drive is designed as a pneumatic cylinder, in particular as a double-acting pneumatic cylinder, and that a control valve is assigned to the linear drive, which is designed to control a fluid supply for the linear drive. The use of a pneumatic cylinder is advantageous because a compressed air supply to the processing machine must be provided anyway for the actuation of the collets. In principle, a single-acting pneumatic cylinder can be used to move the first coupling part between the rest position and the coupling position. In this case, when pressurized, the pneumatic cylinder performs a relative movement of a piston rod relative to a cylinder housing in a first spatial direction along the straight line of movement, while movement of the piston rod relative to the cylinder housing in a second spatial direction, which is opposite to the first spatial direction, is effected by an internal or external return device, in particular a spring arrangement. It is preferable that the linear drive is designed as a double-acting pneumatic cylinder in which the piston rod can be moved in both opposite spatial directions by pressurizing a first working chamber and a second working chamber formed in the pneumatic cylinder. A control valve is provided for venting (aerating) and de-venting (de-aerating) at least one working chamber, preferably two working chambers, of the pneumatic cylinder, which, depending on the design of the pneumatic cylinder, may be, for example, a 3/2-way valve for a single-acting pneumatic cylinder or a 5/2-way valve or a combination of two 3/2-way valves for a double-acting pneumatic cylinder. The control valve can be designed as a switching valve or as a proportional valve and can be provided for electrical control, in particular for electromagnetic control.

In a further development of the invention, the machine base is designed to have a machine frame and a tool table moveably mounted to the machine frame, such that the tool table can move linearly along the axis of rotation. The tool table has a tool surface arranged opposite the workpiece surface of the workpiece rotary table, on which tool surface several tool holders are arranged at the same angular intervals as the angular intervals of the collets which are mounted on the workpiece rotary table. In such a design of the processing machine, it is provided that a linear stroke movement aligned along the axis of rotation, also referred to as an oscillating movement, is performed between the workpiece rotary table and the tool table. Preferably, the tool table performs exclusively the linear stroke movement, and the workpiece rotary table performs exclusively the rotary step movement around the axis of rotation. With these movements of the tool table and the workpiece rotary table it is possible to ensure that container blanks held in the collets sequentially come into contact with the machining tools held on the tool table.

In a further embodiment of the invention, at least one component from the group comprising a linear drive with a first coupling part, a control valve, a fluid valve, a pulse generator, and an electric valve control is arranged on the tool table, in particular on the tool surface. This enables short fluid connections, in particular hose lines, between the valves and the associated fluid consumers. In addition to the linear drives for moving the first coupling parts, fluidic pulse generators are particularly noteworthy here, which are used to provide a short burst of compressed air with which the pneumatic valves associated with the collets can be switched. In this case, the pneumatic valves associated with the collets are prepared for a switching between the blocking position and the release position and for switching between the release position and the blocking position by providing the provide a short burst of compressed air from the fluidic pulse generators to the respective valves. It is preferable to provide an electrical connection and a compressed air connection between the machine frame and the tool table, via which both the electrical supply to an electrical valve control and the compressed air supply to this valve control can be ensured. The valve control, also known as a valve island, comprises an electronic control unit and a plurality of valves with which compressed air flows to the compressed air consumers associated with the tool table can be influenced. It is preferable for the valve control to communicate with a machine control system of the processing machine, in particular a programmable logic controller (PLC), via a communication line, in particular a bus communication line.

It is advantageous if the tool holder is designed to hold processing tools from the group: pulling tool, necking tool, milling tool, flanging tool, rolling tool. These are machining tools that are typically used in a drawing machine (necking machine). A drawing machine is used to machine an end area of the container blank so that, for example, a valve can be placed on the container blank when it is later used as an aerosol can.

It is preferred that several work stations, in particular from the group: printing station, activation station, curing station, are arranged on the machine base, which are designed for machining a side surface of a container blank held in the collet. Such work stations are used to decorate a side surface of the container blank using an inkjet printer process, so that the processing machine is a digital printing machine.

In a further embodiment of the invention, it is provided that the second coupling parts are arranged on the workpiece surface of the workpiece rotary table. This arrangement of the second coupling part is advantageous if a tool surface of a tool table is arranged opposite the workpiece surface of the workpiece rotary table, as is particularly the case with a drawing machine. Due to the oscillating movement that the tool table performs relative to the workpiece rotary table, there is a permanent change in the distance between the tool table and the workpiece rotary table, which can be described in particular by a sine curve. In principle, it could be considered to carry out the compressed air transmission between the first coupling part and the second coupling part during a period of time in which the distance between the tool table and the workpiece rotary table is minimal. However, this period of time is very short at an oscillation frequency for the stroke movement of the tool table, which can be up to 5 Hz during normal use of the processing machine. This period could be extended by mounting the first coupling part on a linear guide, for example spring-loaded, so that it comes into sealing contact with the second coupling part before the minimum distance between the tool table and the workpiece rotary table is reached. With this type of fluid coupling, an actuator, in particular a linear actuator, would not be necessary.

In an advantageous further development of the invention, it is envisaged that the pneumatic valves are designed for contactless switching between the ventilation position and the venting position and/or that the pneumatic valves are arranged on the workpiece surface of the workpiece rotary table. Contactless switching means that there is no mechanical contact between the pneumatic valve and a device provided for controlling the pneumatic valve. For example, it is provided that the pneumatic valve is switched by a burst of compressed air supplied by a pulse generator arranged opposite the pneumatic valve. Alternatively, a contactless inductive or magnetic switching of the pneumatic valve can be provided, in which a pulse generator arranged opposite the pneumatic valve provides a magnetic flux that is generated either by an electric coil arrangement or by a permanent magnet.

It is preferred that the pneumatic valves are arranged on a first circle aligned concentrically with the axis of rotation and that at least one pulse generator is arranged on the machine base, which pulse generator is designed to control the pneumatic valves and which is arranged on a second circle aligned concentrically with the axis of rotation, whereby the first circle and the second circle in particular, have at least essentially the same diameter. This ensures that the at least one pulse generator is arranged opposite the pneumatic valves in such a way that, at a minimum distance between the tool table and the workpiece rotary table, which is typically accompanied by a rest phase for the tool table between two successive rotary step movements, the pulse transmission required to switch the pneumatic valve can be carried out.

It is advantageous if several second coupling parts are arranged on the workpiece rotary table in an angular interval that corresponds to an angular interval of the collets. This ensures that a fluidically communicating connection of the fluid coupling can be achieved in every rest position of the workpiece rotary table.

It is preferable that at least two first coupling parts are arranged on the machine base, in particular on the tool table, in an angular interval corresponding to half the angular interval of the collets.

It is advantageous if a check valve is arranged in a fluid line extending from the second coupling part to the compressed air reservoir, which is designed to release the fluid line when there is a positive pressure difference between the second coupling part and the compressed air reservoir. The check valve ensures in a simple manner that any excess pressure present in the compressed air reservoir is only supplied to the collets and does not escape into the environment after the first coupling part has been disconnected.

In an advantageous further development of the invention, it is envisaged that a product consisting of a number of the first coupling parts and a number of the second coupling parts corresponds to at least one number of the collets on the workpiece rotary table.

### BRIEF DESCRIPTION OF THE DRAWINGS

An advantageous embodiment of the invention is shown in the drawing. Here shows:

FIG. 1 a strictly schematic top view of a processing machine designed as a drawing machine, which has a machine base with a machine frame and a tool table and a workpiece rotary table,

FIG. 2 a strictly schematic front view of the workpiece rotary table,

FIG. 3 a strictly schematic front view of the tool table,

FIG. 4 a strictly schematic representation of a fluid coupling.

### DETAILED DESCRIPTION

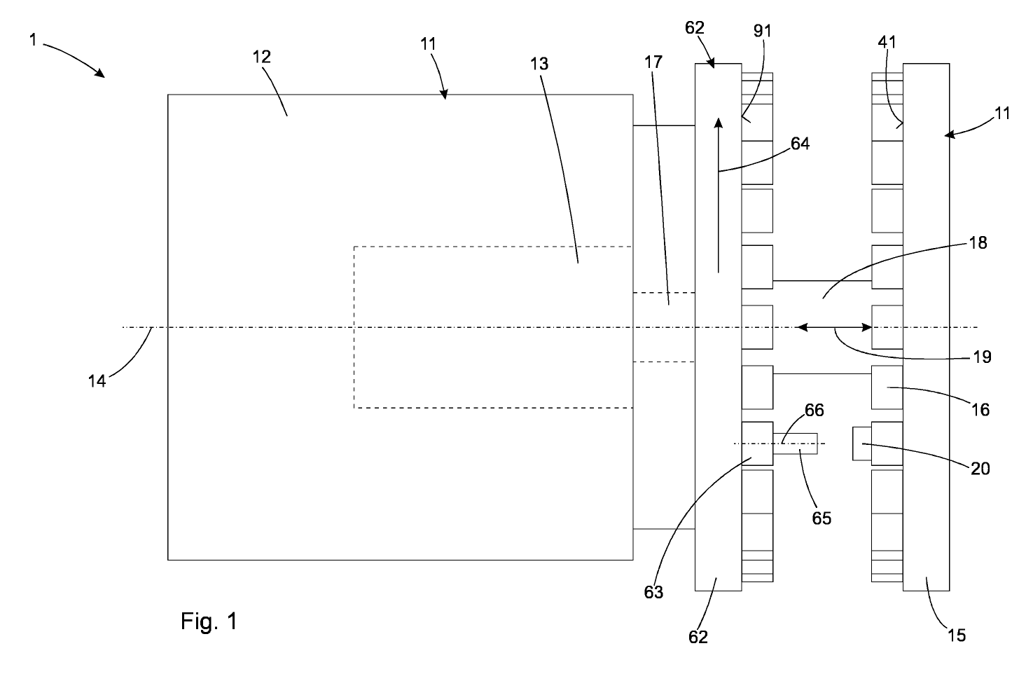

A processing machine 1, shown only schematically in FIG. 1, is designed purely as an example of a drawing machine for processing container blanks 65. For reasons of clarity, only a single container blank 65 is shown in the illustration in FIG. 1, which is held in a force-fitting manner by friction forces in one of the collets 63 of a workpiece rotary table 62. Opposite the workpiece rotary table 62, which, when the processing machine 1 is used as intended, performs a rotary step movement about a rotary axis 14 in a direction of rotation 64, a tool table 15 is located, which is designed to perform a linear oscillating movement 19 along the rotary axis 14. The tool table 15 is provided with tool holders 16, which are arranged in the same angular interval as the collets 63 on the workpiece rotary table 62. Purely by way of example, a machining tool 20 is arranged in one of the tool holders 16, which is a drawing tool for plastic deformation of the container blank 65, shown only schematically.

The processing machine 1 can be schematically divided into a machine base 11 and a carrier part 61. For the purposes of the following description, the processing machine 1 is divided in such a way that the machine base 11 comprises a machine frame 12 with a drive 13, which is shown only schematically, and the tool table 15 with the tool holders 16 mounted thereon, and a guide tube 18 connected to the tool table 15. The carrier part 61 comprises the workpiece rotary table 62 with the collets 63 mounted thereon.

The drive 13 associated with the machine base is for example an electric motor and has a drive shaft 17 rotatable about the axis of rotation 14. The drive shaft 17 is connected at its front end to the workpiece rotary table 62. When electrical energy is supplied to the drive 13, the drive shaft 17 and the associated workpiece rotary table 62 are rotated in the direction of rotation 64 around the axis of rotation 14. This supply of electrical energy to the drive 13 is carried out in such a way that the workpiece rotary table 62 performs a rotary step movement in which the workpiece rotary table 62 performs a swivel movement from a rest position by a predetermined angle corresponding to the angular interval of the collets 63 in order to assume a new rest position. It is provided that, in the respective rest position, a coaxial alignment of the collets 63 with the container blanks 65 received therein and of the tool holders 16 with the machining tool 20 received therein is ensured.

The linear oscillating movement 19, which is provided to the tool table 15 by a further drive (not shown in FIG. 1), causes the tool table 15 to move closer to the workpiece rotary table 62 starting from the position of the tool table 15 shown in FIG. 1. In this process, the machining tool 20 engages with an end region of the container blank 65 facing away from the collet 63. During this engagement the machining tool 20 may plastically deform the container blank 65 by a small amount. In the intended mode of operation for the processing machine 1, several of the tool holders 16 are equipped with machining tools 20, so that several container blanks 65 arranged opposite each other can also be (synchronously) machined in the course of an oscillating movement of the tool table 15. Due to the synchronization between the linear oscillating movement 19 for the tool table 15 and the rotational movement around the axis of rotation 14 for the workpiece rotary table 62, the container blanks 65 held on the workpiece rotary table 62 come into contact with the machining tools 20 held on the tool table 15 in a sequential order and can thus be machined step by step, in particular plastically deformed.

The collets 63 attached to the workpiece rotary table 62 for holding the container blanks 65 are designed for pneumatic control. For example, it is envisaged that the collets 63 can be moved from a release position, in which a container blank 65 can be inserted into the collet 63 with low friction or removed from the collet 63 with low friction, to a locking position in which the container blank 65 is held in the collet 63 by friction forces (force-fit). Alternatively, it is envisaged that the collets 63 can be moved from a locking position into a release position by applying compressed air.

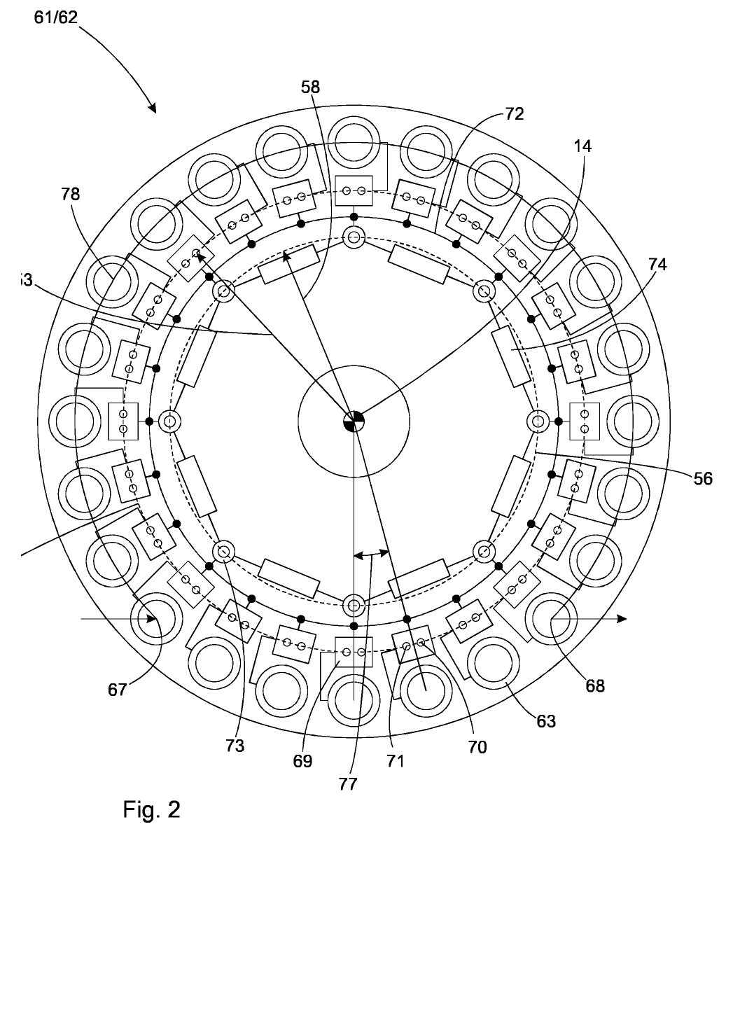

In any case, in order to ensure high-quality machining of the container blanks 65, it is necessary that when the container blanks 65 are fed to the workpiece rotary table 62, which feeding process is carried out at a loading position 67 as shown in FIG. 2, the friction between the container blank 65 and the collet 63 is kept as low as possible when the container blank 65 is inserted into the collet 63 along the container axis 66 and parallel to the axis of rotation 14. During the subsequent movement of the container blank 65 along a circularly shaped movement path 69 in the direction of an unloading position 68, however, it must be ensured that the processing forces and acceleration forces that occur do not lead to a change in position between the container blank 65 and the collet 63. At the unloading position 68, a low-friction linear relative movement along the container axis 66 between the container blank 65 and the collet 63 must again be ensured for the removal process of the container blank 65. In order to meet these requirements, the collets 63 are each connected to individually assigned pneumatic valves 69 in a fluidically communicating manner. Each of the valves 69 is used to selectively release or block the supply of compressed air to the respective collet 63. For example, the pneumatic valves 69 are designed for contactless switching between a ventilation position for the collet 63 and a venting position for the collet 63. This contactless switching is performed purely by way of example by means of compressed air pulses, which are each supplied to one of two control openings 70, 71 formed on the respective pneumatic valve 69. For reasons of clarity, only the compressed air supply for the pneumatic valves 69 is shown in FIG. 2. In practice, each of the pneumatic valves 69 also has an outlet connection to which, for example, a silencer (not shown) can be connected in order to dampen the noise generated when switching from the ventilation position to the venting position and the resulting escape of compressed air from the collet 63 through the pneumatic valve 69.

The compressed air supply for the pneumatic valves 69 is provided, purely by way of example, by a ring line 72 to which all pneumatic valves 69 are connected in a fluidically communicating manner. This ring line 72 is in turn connected in a fluidically communicating manner to second coupling parts 73, which are described in more detail below. Furthermore, compressed air reservoirs 74, which have a storage volume for compressed air (not shown), are connected in a fluidically communicating manner between adjacent second coupling parts 73.

The second coupling parts 73 together with first coupling parts 23 form a fluid coupling 22 with which a compressed air supply can be carried out from the machine base 11, in particular from the tool table 15, to the workpiece rotary table 62.

As can be seen from the purely schematic representation in FIG. 4, the second coupling part 73 is a combination of a second coupling plate 75, a second ring seal 76, and a check valve 80, which is arranged in a fluid line 81 that is fluidically connected to the respective compressed air storage units 74 and the ring line 72. A front side of the second ring seal 76 facing the first ring seal 26 defines a sealing plane 79 aligned transversely to the axis of rotation 14, in which the sealing contact of the first ring seal 26 is provided. The check valve 80 is arranged in such a way that it is basically in a closed position, from which it is only moved to an open position if excess pressure is supplied to the second coupling part 73 from the first coupling part 23. The second coupling part 73 is fixedly attached to a purely exemplary circular workpiece surface 91 of the workpiece rotary table 62, to which the collets 63 are also attached.

As can be seen from the illustration in FIG. 2, the collets 63 are arranged at constant angular intervals relative to the axis of rotation 14 on the workpiece surface 91. Purely as an example, the workpiece rotary table 62 is equipped with twenty-four collets 63, so that collets 63 arranged adjacent to each other are arranged at an angle 77 of 15 degrees relative to the axis of rotation 14. Accordingly, the workpiece rotary table 62 performs movements with an angular amount of 15 degrees in each case.

In order to ensure an advantageous compressed air supply for the collets 63, a total of eight second coupling parts 73 arranged at equal angular intervals are provided on the workpiece surface 91, which can be brought into fluid communication with the first coupling parts 23 described in more detail below.

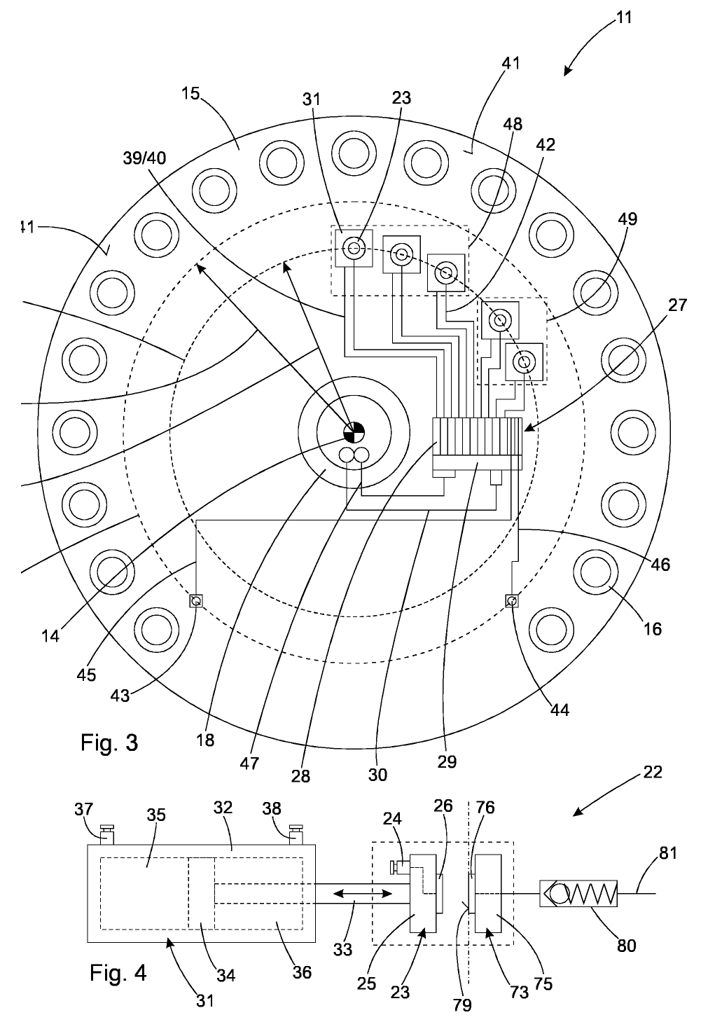

As can be seen from the schematic representation in FIG. 4, the first coupling part 23 is essentially formed by a first coupling plate 25 with a ring seal 26, whereby the first coupling plate 25 is attached, purely by way of example, to an axial end face of a piston rod 33 of a linear drive 31 serving as a coupling rod. On a rear side of the first coupling part 23 facing away from the second coupling part 73, a fluid connection 24, which is designed purely as an example as a hose connection, is provided, which, according to the illustration in FIG. 3, is connected in a fluid-communicating manner via a fluid line 42 to a valve 28 of a valve island 27.

The linear drive 31 comprises a cylinder housing 32, which is designed in a purely exemplary rectangular shape and is also referred to as a drive housing, which is fixed in a manner not shown in detail to a tool surface 41 of the tool table 15. The piston rod 33 of the drive 31 is aligned parallel to the axis of rotation 14 and is connected to a working piston 34, which is linearly movable in a cylinder recess of the cylinder housing 32. The working piston 34 separates a first variable-size working chamber 35 from a second variable-size working chamber 36, which can each be ventilated and vented via associated working connections 37, 38 in order to cause linear movement of the working piston 34. The working connections 37, 38 are connected to a valve 28 of the valve island 27 via fluid lines 39, 40, which are shown as a common line in the schematic representation of FIG. 3.

In addition to the valves 28, the valve island 27 comprises a valve control 29 which is designed for a control of the respective valves 28. For example, it is envisaged that the valves 28, which are connected in a fluid-communicating manner to the first coupling parts 23 and which are intended for releasing or blocking compressed air for the first coupling parts 23, are each designed as 2/2-way valves, in particular as solenoid valves. Furthermore, it may be provided, purely by way of example, that the valves 28, which are fluidically connected to the linear drives 31 via the fluid lines 39, 40, are each designed as 5/2-way valves. The valve island 27 is in fluid communication with a compressed air source (not shown) associated with the machine frame 12 via a supply line 30 which extends through the guide tube 18 in the machine frame 12. Furthermore, the valve island 27 is electrically connected via a communication line 47, which extends through the guide tube 18 into the machine frame 12, to a machine control system, in particular a programmable logic controller (PLC), associated with the machine frame 12 (not shown).

Furthermore, it is provided that the valve island 27 has two further valves 28 which are connected via fluid lines 45, 46 to a first pulse generator 43 and a second pulse generator 44, respectively.

The task of the first pulse generator 43 is to provide a compressed air pulse to the first control opening 70 of the pneumatic valve 69 located at the loading position 67 when there is a minimum distance between the tool table 15 and the workpiece rotary table 62. By this compressed air pulse the pneumatic valve 69 is switched from the venting position (de-aerating position) for the collet 63 to the ventilating position (aerating position) for the collet 63 after the container blank 65 has been inserted into the collet 63. By this specific operation of the pneumatic valve 69 a low friction insertion of the container blank 65 into the respective collet 63 and afterwards a securing of the container blank 65 at the loading position 67 is achieved.

The task of the second pulse generator 44 is to provide a compressed air pulse to the second control opening 71 of the pneumatic valve 69 located at the unloading position 68 when there is a minimum distance between the tool table 15 and the workpiece rotary table 62. With this compressed air pulse the pneumatic valve 69 is switched from the ventilation position for the collet 63 to the venting position for the collet 63 and thus enables a container blank to be removed from the respective collet 63 at the unloading position 67 with low friction.

In practice, additional valves of the valve island, which are not shown, can be used to control additional pulse generators, which are not shown, at other positions away from the loading position and the unloading position.

According to the illustration in FIG. 3, a total of five first coupling parts 23 are arranged on the tool surface 41, whereby three of the first coupling parts 23 belong to a first group 48 and a further two of the first coupling parts 23 belong to a second group 49. The first coupling parts 23 of the first group 48 are arranged in the same angular interval as the tool holders 16 on the workpiece rotary table 15 and, during normal operation of the processing machine 1, serve to transfer compressed air between the tool table 15 and the workpiece rotary table 62. The arrangement of the first coupling parts 23 of the first group 48 ensures that, during each rotary step movement performed by the workpiece rotary table 62, a first coupling part 23 comes into fluid communication with one of the second coupling parts 73.

The first coupling parts 23 belonging to the second group 49 are arranged offset by half an angular interval with respect to the angular interval of the tool holders 16 relative to the first coupling parts 23 of the first group 48 and can be used if the workpiece rotary table 62 has been shifted by only half a rotational step relative to the tool table 15, for example when performing maintenance work.

While the first coupling parts 23 of the first group 48 are absolutely necessary for the intended operation of the processing machine 1, the first coupling parts 23 of the second group 49 are merely optional and can also be omitted.

As can be seen from the illustrations in FIGS. 2 and 3, the pneumatic valves 69 are arranged on a first circle 51 and the pulse generators 43, 44 are arranged on a second circle 52. Preferably, a first radius 53 of the first circle 51 is equal to a second radius 54 of the second circle 52.

As can be seen from the illustration in FIG. 2, the second coupling parts 62 are arranged on a fourth circle 56. Furthermore, it can be seen from the illustration in FIG. 3 that the first coupling parts 23 are arranged on a third circle 55. Preferably, a third radius 57 of the third circle 55 is equal to a fourth radius 58 of the fourth circle 56.

The mode of operation of the processing machine 1 can be explained as follows: at a given point in time, the workpiece rotary table 62 is at rest and the tool table 15 is arranged at an axial distance from the workpiece rotary table 62. At the loading position 67, a container blank 65 is provided by means of a feeder (not shown) and is arranged at a certain distance coaxially with the collet 63 located at the loading position 67. The tool table 15 then moves closer to the workpiece rotary table 62 in order to insert the container blank into the collet 63. As long as the workpiece rotary table 62 is at rest, the linear drive 31 whose associated first coupling part 23 is located opposite a second coupling part 73 is supplied with compressed air from the valve island 27 in such a way that the piston rod 33 extends and thus reduces the distance between the first coupling part 23 and the second coupling part 73. In the course of this approach movement, the first coupling part 23 comes into sealing contact with the second coupling part 23, so that compressed air can be supplied from the first coupling part 23 to the second coupling part 73 in order to fill the compressed air reservoirs 74. For example, it is envisaged that the valve control 29 provides (closed loop) force control for the valve 28 used for the compressed air supply to the linear drive 31, so that a constant drive force between the first coupling part 23 and the second coupling part 73 is always ensured during the approach movement. During the approach movement of the tool table 15 to the workpiece rotary table 62, a push-on slider (not shown) mounted on the tool table 15 in the corresponding tool holder 16 comes into contact with an end face of the container blank 65 and causes the container blank 65 to be inserted into the coaxially arranged collet 63. This assumes that the collet 63 is in a release position in order to ensure that the container blank is inserted with as little friction as possible. For this purpose, it is preferably provided that the pneumatic valve 69 of this collet 63 is in a venting (de-aerating) position. As soon as the tool table 15 is at a minimum distance from the workpiece rotary table 62, the valve island 27 controls the first pulse generator 43 in order to achieve the delivery of a compressed air pulse from the first pulse generator 43 to the first control opening 70 of the oppositely arranged pneumatic valve 69 and thereby to cause this pneumatic valve 69 to be transferred from the venting position (de-aerating position) to the ventilation position (aerating position). This switchover of the pneumatic valve 69 supplies compressed air to the collet 63, which then clamps the previously inserted container blank. During the subsequent removal movement between the tool table 15 and the workpiece rotary table 62, the force control for the linear drive 31 is maintained at least temporarily. As the distance between the tool table 15 and the workpiece rotary table 62 increases, the compressed air transmission between the first coupling part 23 and the second coupling part 73 is interrupted and the valve control 29 controls the valve 28 used to supply the linear drive 31 in such a way that the piston rod 33 retracts, whereby the first coupling part 23 is removed from the second coupling part 73 and the rotary step movement for the workpiece rotary table 62 can then be performed. Looking at the container blank 65 fed to the loading position 67 in accordance with the above description, this is moved along a movement path 78 designed as a circular arc section to the unloading position 68 in the course of subsequent rotary step movements of the workpiece rotary table 62 and associated oscillating movements of the tool table 15. At the unloading position 68, with a minimum distance between the tool table 15 and the workpiece rotary table 62, the second pulse generator 44 is activated by the valve island 27, whereby a pressure pulse is delivered to the second control opening 71 of the pneumatic valve 69 in order to transfer this pneumatic valve 69 from the ventilation position to the venting position and thus release the force-fit clamping of the container blank 65. To ensure that the container blank 65 does not move into an undesirable position after being released by the collet 63, a container gripper (not shown) is accommodated in the associated tool holder 16 opposite the unloading position 68, with which the container blank 65 can be gripped and transferred to a transport system (not shown).

It is understood that, when the processing machine 1 is used as intended, a container blank 65 is fed to the loading position 67 and a container blank 65 is removed at the unloading position 68. Furthermore the container blanks 65 held in the collets 63 along the movement path 78 are modified by unillustrated processing tools that are held in the tool holders 16 of the tool table 15.

In order to be able to adjust the holding force for the collets 63, an optionally provided, electrically adjustable pressure control valve, which is not shown, can be provided between the compressed air source, which is not shown and is assigned to the machine frame 12, and the valve island 27, with which the supply pressure for the valve island 27 can be adjusted. Alternatively, it can be provided that the valve 28, which are connected in a fluidic manner to the first coupling parts 23 and which are intended for the release or blocking of compressed air for the first coupling parts 23, are capable, by means of a suitable electrical control, of adjust the pressure of the compressed air supplied to the second coupling parts 73.

1. A processing machine for machining container blanks, with a machine base and with a workpiece rotary table, wherein the workpiece rotary table is mounted rotatably about a rotational axis on the machine base, and with a drive fixed to the machine base to provide a rotary step movement for the workpiece rotary table, wherein pneumatically actuated collets are attached to a workpiece surface of the workpiece rotary table to provide releasable fixing of container blanks on the workpiece rotary table, wherein each collet is assigned a pneumatic valve which can be switched between a ventilation position for the collet and a venting position for the collet, wherein a plurality of the pneumatic valves are connected to a compressed air reservoir fixed to the workpiece rotary table, and with a fluid coupling to supply compressed air to the compressed air reservoir, which fluid coupling has a first coupling part that is movably mounted on the machine base, and which fluid coupling has a second coupling part that is arranged opposite the first coupling part on the workpiece rotary table, wherein the first coupling part bears sealingly against the second coupling part in a coupling position and is spaced from the second coupling part in a rest position.

2. The processing machine according to claim 1, wherein a drive housing of a linear drive is attached to the machine base and wherein the first coupling part is attached to a coupling rod of the linear drive for performing a linear movement of the first coupling part relative to the drive housing in order to move the first coupling part between the rest position and the coupling position.

3. The processing machine according to claim 2, wherein a fluid valve is assigned to the first coupling part to supply compressed air from the first coupling part to the second coupling part when the first coupling part is arranged in the coupling position.

4. The processing machine according to claim 2, wherein the linear drive is a pneumatic cylinder and wherein a control valve is assigned to the linear drive to control a fluid supply for the linear drive.

5. The processing machine according to claim 1, wherein the machine base has a machine frame and a tool table mounted to the machine frame so as to be linearly movable along the axis of rotation, wherein the tool table has a tool surface arranged opposite the workpiece surface, on which tool surface a plurality of tool holders are arranged at the same angular spacing as the angular spacing of the collets.

6. The processing machine according to claim 5, wherein at least one component from the group: linear drive with first coupling part, control valve, fluid valve, pulse generator, electric valve control, is arranged on the tool table.

7. The processing machine according to claim 5, wherein the plurality of tool holders is designed to hold machining tools from the group: drawing tool, milling tool, flanging tool, rolling tool.

8. The processing machine according to claim 1, wherein several work stations from the group: pressure station, activation station, curing station, are arranged on the machine base, which are designed for machining a side surface of a container blank held in the collet.

9. The processing machine according to claim 1, wherein the second coupling parts are arranged on the workpiece surface of the workpiece rotary table.

10. The processing machine according to claim 1, wherein the pneumatic valves are designed for contactless switching between the ventilation position for the collet and the venting position for the collet and/or wherein the pneumatic valves are arranged on the workpiece surface of the workpiece rotary table.

11. The processing machine according to claim 10, wherein the pneumatic valves are arranged on a first circle aligned concentrically with the axis of rotation and that at least one pulse generator is arranged on the machine base to control the pneumatic valves, which at least one pulse generator is arranged on a second circle aligned concentrically with the axis of rotation.

12. The processing machine according to claim 1, wherein several second coupling parts are arranged on the workpiece rotary table in an angular interval corresponding to an angular interval of the collets.

13. The processing machine according to claim 12, wherein at least two first coupling parts are arranged on the machine base in an angular interval corresponding to half the angular interval of the collets.

14. The processing machine according to claim 1, wherein a check valve is arranged in a fluid line extending from the second coupling part to the compressed air reservoir, which check valve is arranged to release the fluid line when there is a positive pressure difference between the second coupling part and the compressed air reservoir.

15. The processing machine according to claim 1, wherein a product of a number of the first coupling parts and a number of the second coupling parts corresponds to at least a number of the collets on the workpiece rotary table.
